(19) United States
(12) Patent Application Publication
(10) Pub. No.: US 2013/0110667 A1
(43) Pub. Date: May 2, 2013

(54) SYSTEM AND METHOD FOR CUSTOMER MANAGEMENT OF CUSTOM MEDICAL PROCEDURAL TRAYS

(71) Applicants: Brian C. DeBusk, Knoxville, TN (US); Angela M. Sewell, Knoxville, TN (US); John G. Jacobs, Knoxville, TN (US); Judith R. Barkhurst, Knoxville, TN (US); Rex A. Hurd, Knoxville, TN (US); Jeffrey D. Griffith, Knoxville, TN (US)

(72) Inventors: Brian C. DeBusk, Knoxville, TN (US); Angela M. Sewell, Knoxville, TN (US); John G. Jacobs, Knoxville, TN (US); Judith R. Barkhurst, Knoxville, TN (US); Rex A. Hurd, Knoxville, TN (US); Jeffrey D. Griffith, Knoxville, TN (US)

(73) Assignee: DEROYAL INDUSTRIES, INC., Powell, TN (US)

(21) Appl. No.: 13/287,478

(22) Filed: Nov. 2, 2011

(51) Int. Cl. G06Q 30/06

(52) U.S. Cl. 705/26.5

(57) ABSTRACT

A computer system uses requests from a customer to configure custom medical procedural kits (PACKs) ordered by the customer from a service provider. A service provider computer executes a PACK management application which allows a customer to access a list of components of PACKs associated with a customer account. Preferably, the list of components is accessible for display on the customer computer with no need for personnel of the customer to interact with personnel of the service provider. A PACK database stores configuration and pricing information for each PACK associated with the customer account. The system allows a customer to view bills of materials for PACKs and request changes thereto, request vendor price exceptions for various kit components, submit forecast reports reflecting future need for the kits, submit changes to work orders, view current inventory on hand and in manufacturing of kits.

### FIELD

The present disclosure relates to the manufacture of custom medical procedural trays. More particularly, the disclosure relates to a system that provides a customer the ability to manage components and associated costs associated with the manufacture of custom medical procedural trays in a manner that achieves desired customization while minimizing waste and inefficiency typically associated with customization.

### BACKGROUND

Custom procedural trays are increasingly used by hospitals as one way to reduce supply costs. Custom procedural trays are medical procedural kits made to the specifications of a hospital based on the type of medical procedures to be performed and individual preferences of physicians. For example, such trays include, in a sterilized package, items such as drapes, sponges, scalpels, retractors, sutures, and the like as typically required by a physician for a procedure. The use of such trays enables more ease in billing for supplies and reductions in costs and labor in supplying and stocking such items in a hospital.

Accordingly, the use of custom procedural trays is desirable in many respects, and their use can serve to enable future cost reductions. For example, the use of such trays can promote recognition of what are right-sized appropriately-arranged trays, the prediction of accurate but conservative forecasts for future needs, and identification of line-item opportunities for cost reduction.

However, in practice, it has been observed that the use of such trays can have some detrimental cost effects. For example, while their use can lead to some standardization, it can become expensive to permit even further customization or and/or changes. Also, since only the tray as a package is typically tracked, adaptation for changes to medical procedures can be slow and expensive to implement, which can also result in waste that goes unrecognized. For example, in the event a change to a medical procedure is introduced requiring a new instrument or other supply, it can be expensive to introduce such changes into the manufacturing process. Also, due to costs typically charged for changes, a hospital may make only the changes necessary to add a new component, yet fail to make a change to eliminate a low-cost component that is no longer needed in the new procedure, rationalizing that it is cheaper to pay for and throw away such components rather than pay to have a tray redesigned with the unneeded item removed. On a large scale, this represents considerable waste.

Another complaint of customers is a lack of transparency in the true costs of components utilized as well as the availability of options, such as use of comparable items from different suppliers and any associated cost differences.

What is desired, therefore, is a system that enables a customer to be involved in the manufacture of custom procedural trays in a manner that maintains desirable aspects of the use of such trays to provide enhanced customization and further cost reduction, while avoiding or minimizing many of the undesirable aspects.

### SUMMARY

The above and other needs are met by a system for incorporating requests from a customer in determining the configuration and pricing of custom medical procedural kits ordered by the customer from a service provider. In a preferred embodiment, the system includes a service provider computer in communication with a customer computer via a communication network. The service provider computer executes a custom procedural kit management application to receive customer requests via the communication network and process the customer requests in determining the configuration and pricing of custom medical procedural kits. The custom procedural kit management application allows a customer to access a list of components of one or more custom procedural kits associated with a customer account maintained by the service provider for the customer. Preferably, the list of components is accessible through the communication network for display on the customer computer with no need for personnel of the customer to interact with personnel of the service provider. The system also includes a custom procedural kit database in communication with the custom procedural kit management computer. The custom procedural kit database stores configuration information and pricing information for each custom procedural kit associated with the customer account.

In some embodiments, the custom procedural kit management application receives a customer request to change the configuration of one or more custom procedural kits associated with the customer account.

In some embodiments, the custom procedural kit management application receives a customer request for the service provider to perform an optimization analysis of one or more of the custom procedural kits associated with the customer account.

In these embodiments, the customer request is submitted from the customer computer via the communication network to the service provider computer without personnel of the customer interacting with personnel of the service provider.

In some embodiments, the custom procedural kit management application receives a customer request to add a component to or delete a component from one or more of the custom procedural kits associated with the customer account. The custom procedural kit management application then calculates a new price for the custom procedural kit(s) in which a component is added or deleted. Based on the new price, the custom procedural kit management application generates a price quote for the custom procedural kit(s) in which a component is added or deleted. Preferably, the customer request is submitted, the new price is calculated, and the price quote is generated without personnel of the customer interacting with personnel of the service provider.

In some embodiments, the custom procedural kit management application receives a forecast report from the customer for one or more of the custom procedural kits associated with the customer account. Preferably, the forecast report is submitted from the customer computer via the communication network to the service provider computer without personnel of the customer interacting with personnel of the service provider.

In some embodiments, the custom procedural kit management application receives an electronic vendor price exception request form submitted by the customer. Preferably, the electronic vendor price exception request form is directed to a vendor that supplies one or more components of the custom procedural kits associated with the customer account.

In some embodiments, the custom procedural kit management application generates the electronic vendor price exception request form for the customer to complete and sends the completed electronic vendor price exception request form from the service provider computer via the communication network to the vendor without personnel of the customer interacting with personnel of the service provider.

In some embodiments, the custom procedural kit management application sends the vendor an electronic message containing the electronic vendor price exception request form submitted by the customer. Preferably, the electronic message is sent from the service provider computer via the communication network.

In some embodiments, the electronic vendor price exception request form includes means in the form for the vendor to electronically enter approval or disapproval of the vendor price exception request.

In some embodiments, the electronic vendor price exception request form includes means in the form for the vendor to electronically choose to email the electronic vendor price exception request form to the service provider after the vendor has entered approval or disapproval in the form.

In some embodiments, the custom procedural kit management application generates a work order list indicating pending work orders for the custom procedural kits associated with the customer account. Preferably, the work order list indicates pending work orders that are ready to build and pending work orders that are on hold because one or more components of a custom procedural kit are unavailable. The custom procedural kit management application allows the customer to access the work order list via the communication network and view the work order list on the customer computer without personnel of the customer interacting with personnel of the service provider.

In some embodiments, the custom procedural kit management application generates a component list indicating components of a custom procedural kit associated with a work order that is on hold because one or more components of the custom procedural kit are unavailable. Preferably, the component list includes means for the customer to electronically enter a choice to exclude an unavailable component from the custom procedural kit or a choice to substitute another component for the unavailable component. The customer choice may be entered without personnel of the customer interacting with personnel of the service provider.

In some embodiments, the custom procedural kit management application receives the customer choice, generates a modified work order based on the customer choice, and electronically sends the modified work order to manufacturing for approval.

In some embodiments, the custom procedural kit management application generates a request for a sales order for the modified work order, and electronically sends the request for the sales order to an electronic data interchange server in communication with the custom procedural kit management computer.

In another aspect, an embodiment of the invention provides a method for incorporating requests from a customer in determination of configuration and pricing of custom medical procedural kits ordered by the customer from a service provider. The method is preferably implemented using a service provider computer in communication with a customer computer via a communication network. The service provider computer is also in communication with a custom procedural kit database. The method includes the following steps:
(a) storing in the custom procedural kit database configuration information and pricing information for custom procedural kits associated with a customer account maintained by the service provider for the customer;
(b) accessing from the custom procedural kit database a list of components of the custom procedural kits associated with the customer account;
(c) communicating the list of components through the communication network from the service provider computer to the customer computer;
(d) displaying the list of components on the customer computer;
(e) communicating a customer request through the communication network from the customer computer to the service provider computer, where the customer request relates to the configuration and/or pricing of the custom medical procedural kits associated with the customer account; and
(f) determining the configuration and/or pricing of the custom medical procedural kits associated with the customer account based on the customer request
   Preferably, at least steps (b), (c), (d), (e) and (f) of the method are accomplished without personnel of the customer interacting with personnel of the service provider.

In some embodiments, step (e) includes communicating a customer request to change the configuration of one or more of the custom procedural kits associated with the customer account.

In some embodiments, step (e) includes communicating a customer request for the service provider to perform an optimization analysis of one or more of the custom procedural kits associated with the customer account.

In some embodiments, step (e) includes communicating a customer request to add a component to or delete a component from one or more of the custom procedural kits associated with the customer account, and step (f) includes calculating a new price for the custom procedural kit(s) in which a component is added or deleted. These embodiments also include a step (g) of generating a price quote for the custom procedural kit(s) in which a component is added or deleted based on the new price.

In some embodiments, step (e) includes communicating an electronic vendor price exception request form from the customer computer to a vendor that supplies one or more components of the custom procedural kits associated with the customer account.

In some embodiments, the vendor enters approval or disapproval of the vendor price exception request directly in the electronic vendor price exception request form.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a functional block diagram of an embodiment of a system that provides for customer management of custom medical procedural trays;

FIGS. 2-8 are flowcharts describing the operation of an embodiment of a system that provides for customer management of custom medical procedural trays; and

FIGS. 9-18 depict examples of graphical user interfaces employed in an embodiment of a system that provides for customer management of custom medical procedural trays.

### DETAILED DESCRIPTION

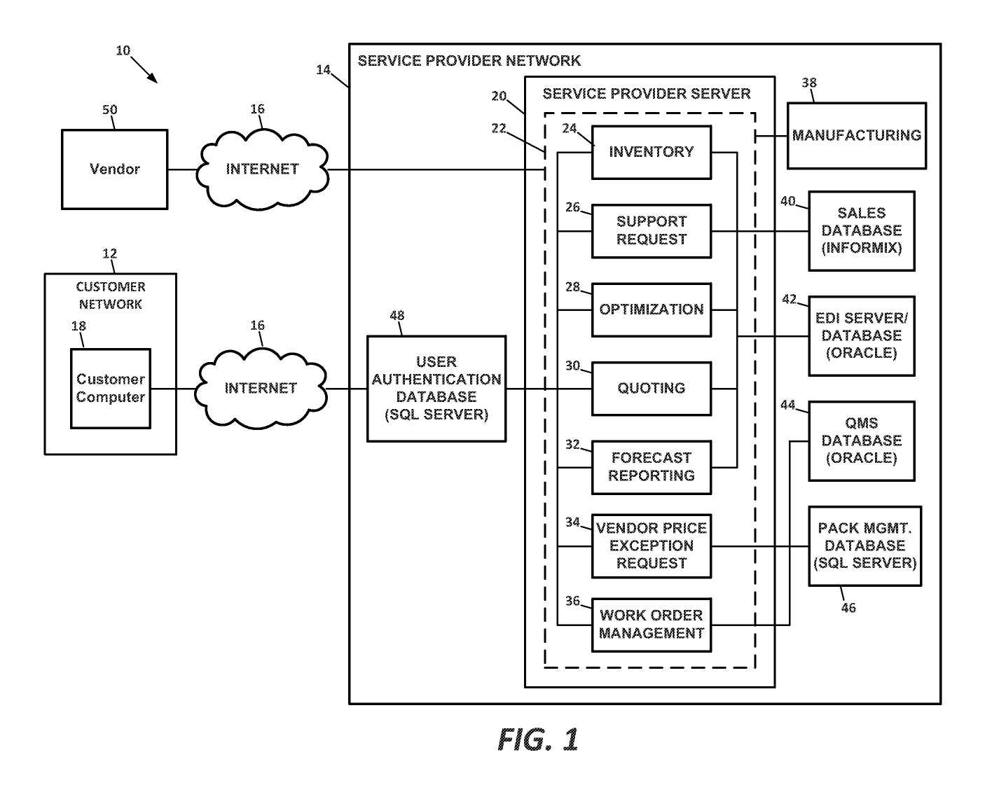

FIG. 1 depicts a customer managed manufacturing system 10 for the manufacture of custom medical procedural trays. A custom procedural tray (CPT) is also referred to herein as a preassembled custom kit (PACK). As described in more detail hereinafter, the system 10 provides computer-implemented tools and processes that enable a customer to have significant involvement in the management of PACK's containing medical supplies and tools used in medical procedures. However, one skilled in the art will recognize that the system 10 may be used to manage customized kits of various other components and materials in medical and nonmedical applications. Thus, the inventions described herein are not limited only to medical product/supply ordering, manufacturing, and inventory management.

As shown in FIG. 1, the system 10 includes a customer computer network 12 and a service provider computer network 14 which communicate with each other via a communication network 16 such as the Internet. As the term is used herein, “customer” generally refers to a medical facility where medical surgical procedures are performed, such as a hospital, outpatient surgical center, or physician's office. The term “customer” may also refer to any consumer of products/supplies that are inventoried and managed using the system described herein. Accordingly, one or more of the components of the customer computer network 12 may be located within a hospital, doctor's office, or other medical facility.

The customer computer network 12 includes a customer computer 18, also referred to herein as a first computer, that is operable to communicate through the Internet 16 with the service provider computer network 14. The customer computer 18 may be, for example, a desktop computer, laptop computer, tablet computer, or smart phone. A browser application is loaded on the customer computer to provide for access to a service provider website via the Internet 16.

With continued reference to FIG. 1, the service provider computer network 14 comprises one or more computers which store information and execute software to support sales, order processing, manufacturing, quality control, billing, and inventory management functions of the service provider. As the term is used herein, a “service provider” may be a company that manufactures and maintains inventories of PACK's that are supplied to the customer to be used in medical surgical procedures. An example of one such service provider is DeRoyal Industries, Inc. of Powell, Tenn. Alternatively, the “service provider” may not do the manufacturing or maintain the inventory of PACK's, but may provide inventory management services for another company that does so.

In the embodiment of FIG. 1, the service provider computer network 14 includes a service provider server computer 20, also referred to herein as a custom procedural kit management computer, running PACK management application 22. In a preferred embodiment, the PACK management application 22 includes an inventory module 24, a support request module 26, an optimization module 28, a quoting module 30, a forecast reporting module 32, a vendor price exception request module 34, and a work order management module 36. The purpose and operation of each of these modules are described in detail hereinafter.

The service provider server computer 20 is in communication with several databases of information related to manufacturing, sales, and inventory management of PACK's. These include a sales database 40, electronic data interchange (EDI) database 42, a quote management system (QMS) database 44, a PACK management database 46, and a user authentication database 48. The service provider server computer 20 is also in communication with a manufacturing operations computer 38 and vendor computers 50 via the Internet 16.

The sales database 40, which may be an IBM Informix database, maintains records of pending and completed orders for sales of PACK's. The EDI database 42, which may be a J.D. Edwards/Oracle database, executes programs for implementing electronic commerce transactions between the service provider network 14 and the customer network 12. The QMS database 44, which may be an Oracle database, stores data related to the PACK quote management system which manages quotations for new and revised PACK configurations. The PACK management database 46, which may be on a SQL server, stores records indicating quantities of each PACK in the service provider's inventory and the contents or Bill of Materials (BOM) for each kit. The user authentication database 48, which may be on a SQL server, stores identification records regarding users (customers) who are authorized to access and use the PACK management application 22.

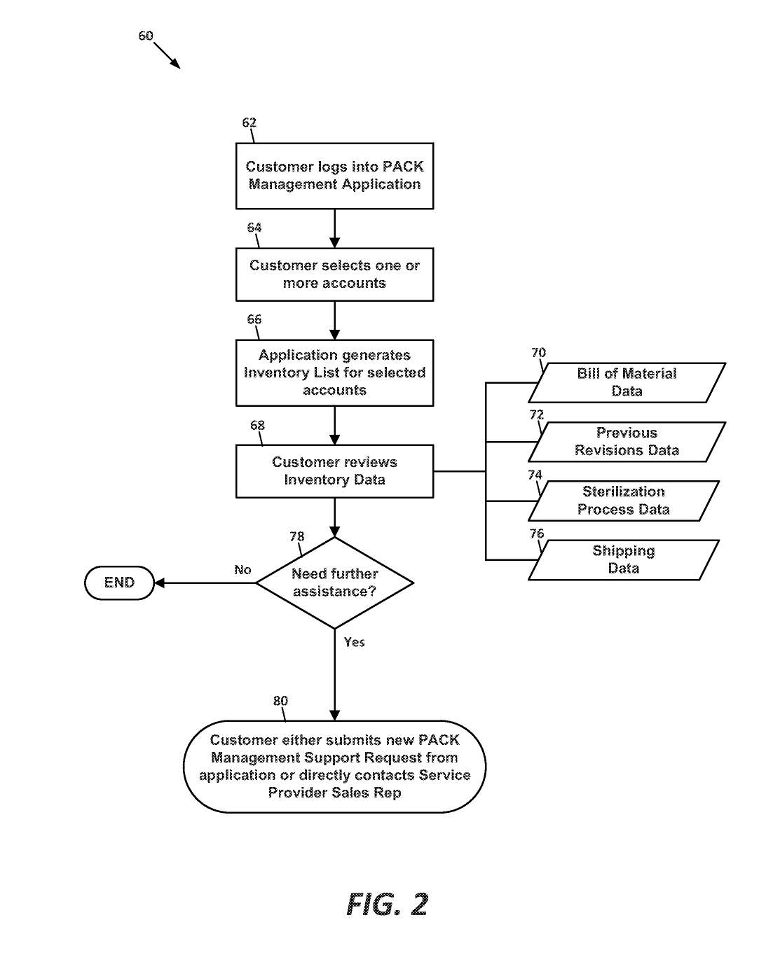

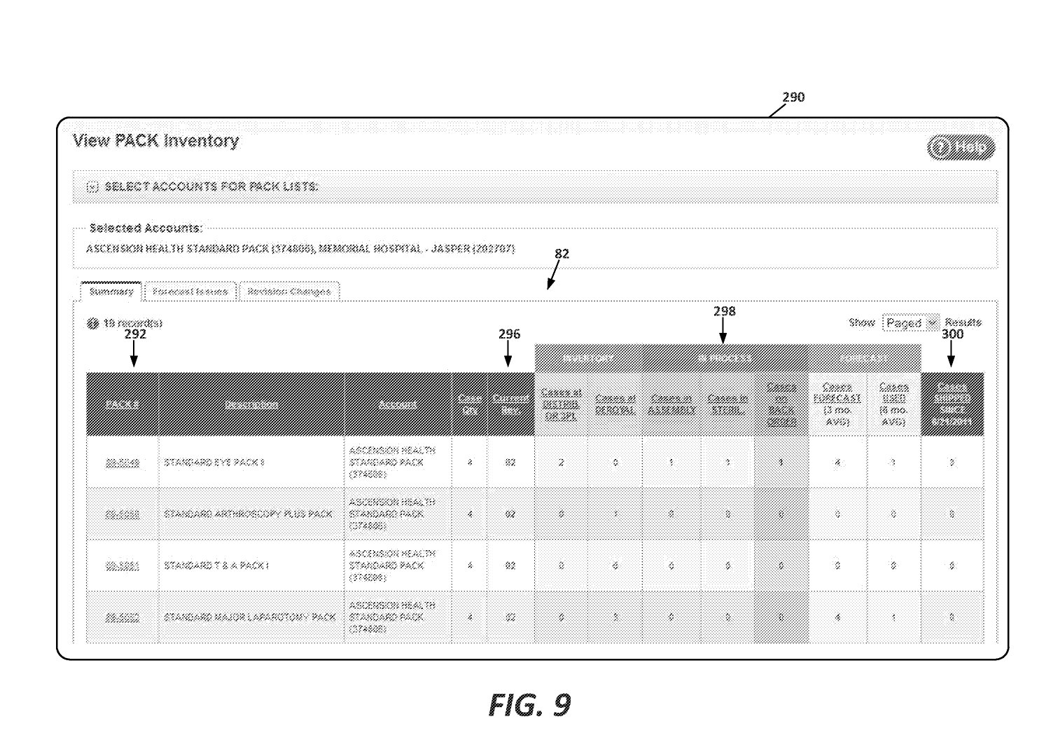

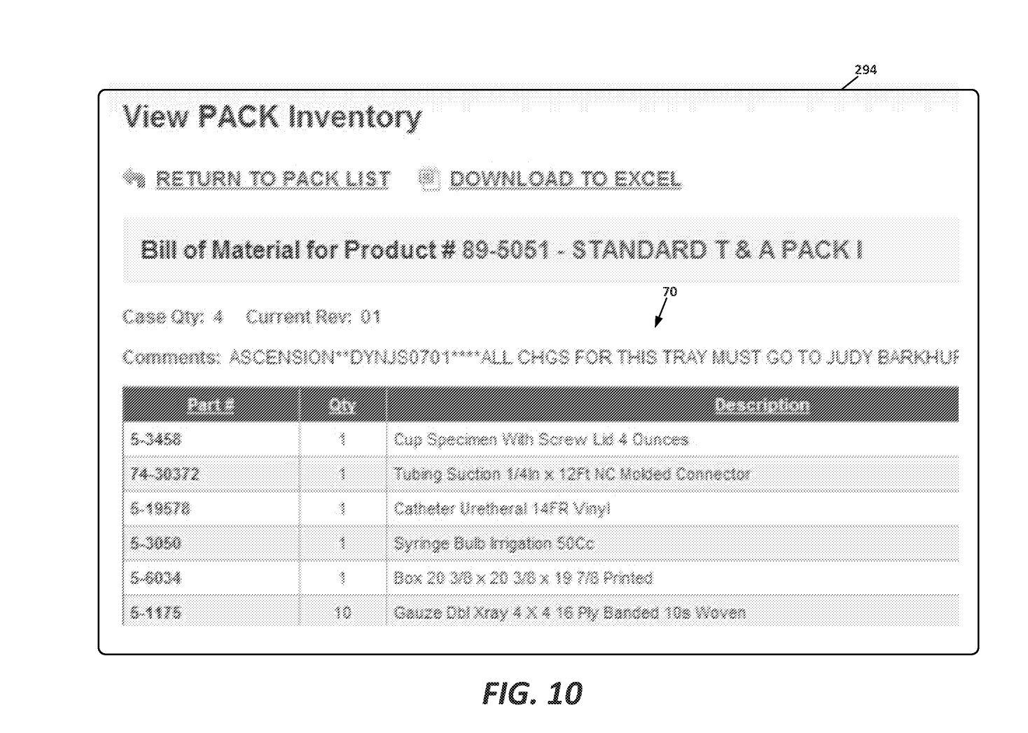

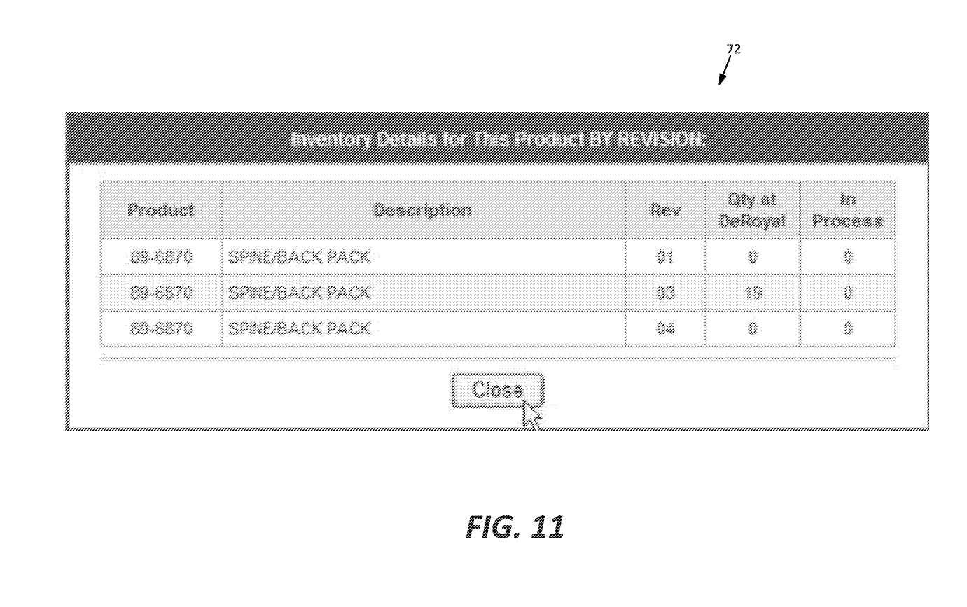

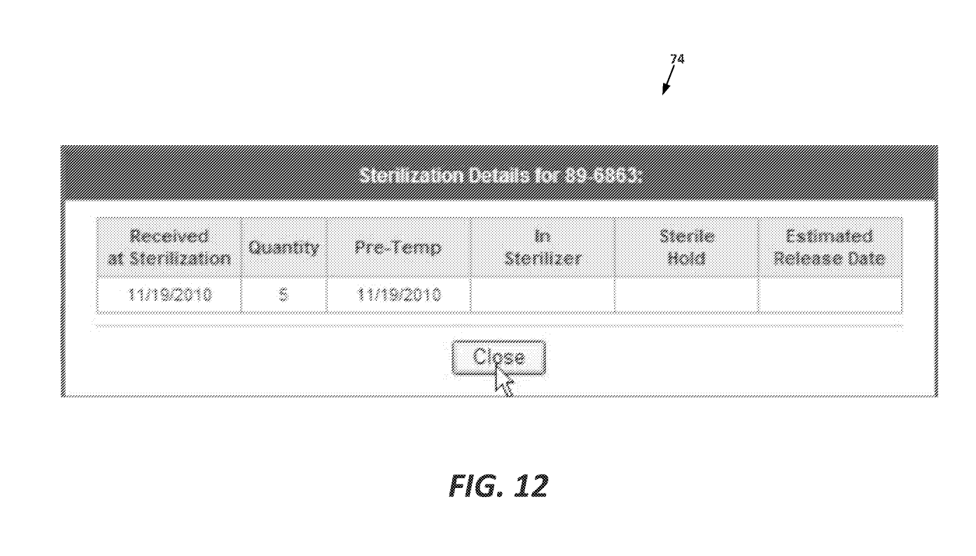

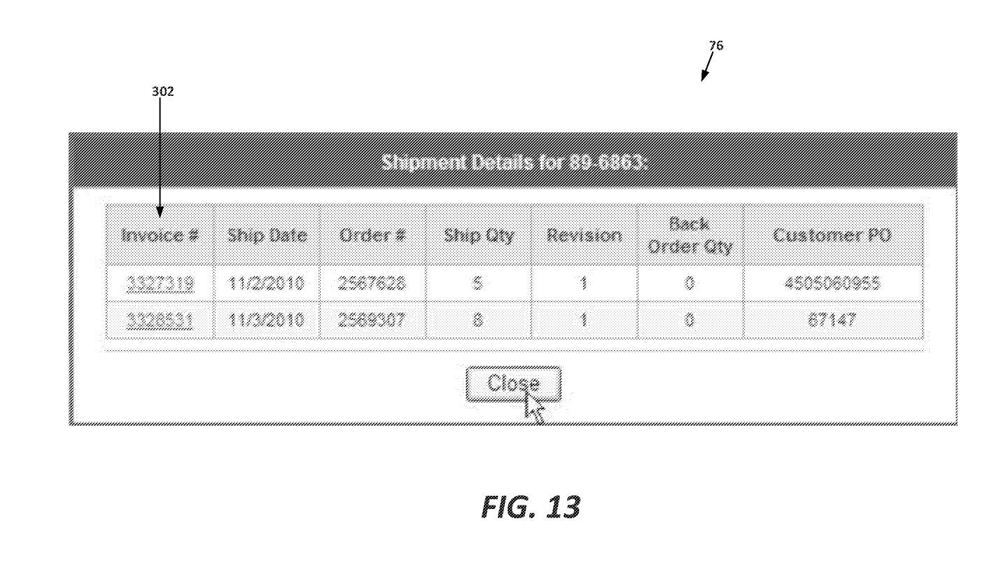

Using the inventory module 24 of the PACK management application 22, a customer may view detailed PACK inventory information for one or more customer accounts to which the customer has access. This module 24 provides for viewing and printing general inventory information, BOMs for each PACK in the inventory list, as well as relevant production, forecast, shipment, and backorder quantity information. FIG. 2 depicts a process 60 for viewing PACK information using the inventory module 24. Using a browser application running on the customer computer 18, a user logs into the PACK management application 22 running on service provider server 20 via the Internet 16 (step 62), and selects the customer accounts for which an inventory list is to be generated (step 64). In one preferred embodiment, this selection is made using a dropdown list displayed in a browser window on the customer computer 18. Based on the selection, the inventory module 24 generates an inventory list for the selected account(s) (step 66). This list preferably includes all PACK's available to be ordered under the selected customer account. FIG. 9 depicts an example of a browser window 290 displaying a PACK inventory list 82. For each PACK in the list 82, the customer may view inventory data (step 68). For example, by clicking on one of the PACK numbers in the “PACK #” column 292, the customer may view a BOM 70, an example of which is depicted in the browser window 294 of FIG. 10. If there have been previous revisions to the BOM of any PACK in the list 82, it will preferably be so noted in a “Current Rev” column 296 in the list 82, and the customer may view the revision data 72 as shown in FIG. 11. If there are items currently being processed in sterilization for a product shown in the list 82, it will preferably be so noted in a “Cases in STERIL” column 298 in the list 82, and the customer may choose to view the sterilization process data 74 as shown in FIG. 12. If a PACK in the list 82 has been shipped in the last 30 days, this will be so denoted in a “Cases SHIPPED” column 300 in the list 82, and the customer may choose to view the shipping data 76 as shown in FIG. 13. If invoice data is available online from the carrier handling the shipment, this will preferably appear as a link in the “Invoice #” column 302 as shown in FIG. 13. If after viewing the inventory information, the customer needs further assistance (step 78), the customer may submit a PACK Management Support Request (as described hereinafter) or directly contact a Service Provider Sales Representative (step 80).

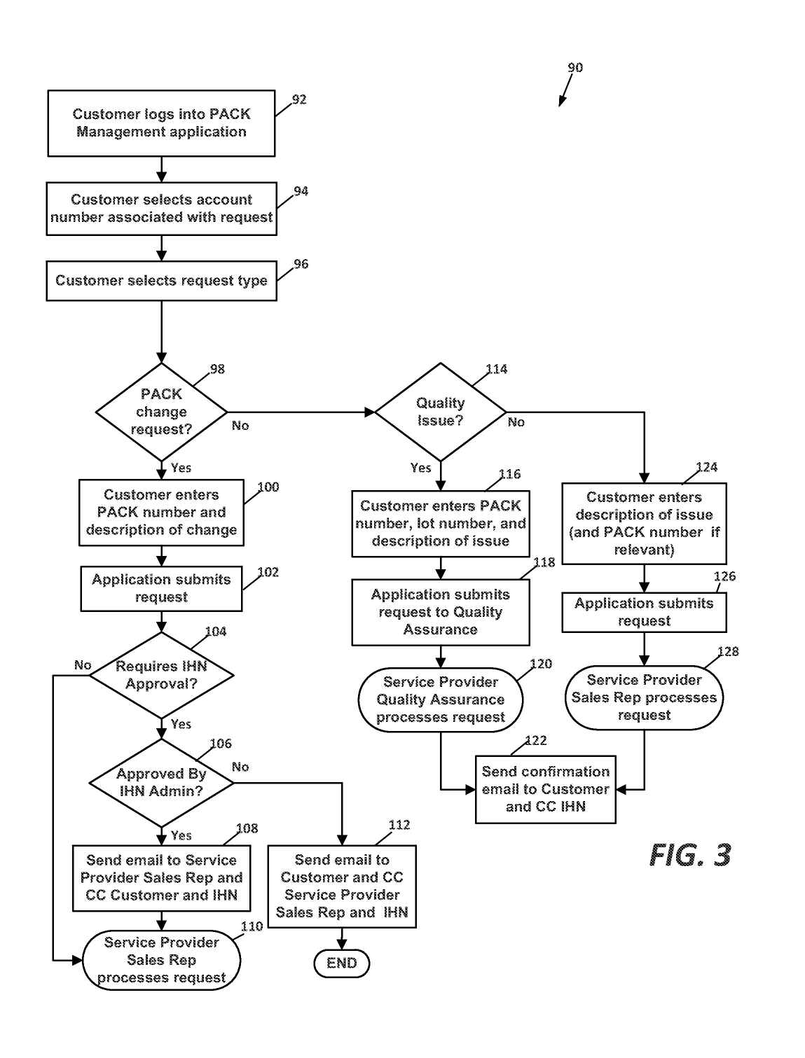

Using the support request module 26 of the PACK management application 22, a customer may submit a support request for one or more customer accounts to which the customer has access. This module 26 provides for submitting support requests to the service provider, monitoring activity associated with an open request, and viewing activity logs for closed requests. FIG. 3 depicts a process 90 for submitting support requests using the support request module 26. Using a browser application running on the customer computer 18, a user logs into the PACK management application 22 running on service provider server 20 via the Internet 16 (step 92), and selects the customer account for which a support request is to be generated (step 94). In one preferred embodiment, this selection is made using a dropdown list displayed in a browser window on the customer computer 18. The customer then selects the type of request (step 96), which may be a PACK change request, a quality issue request, or other.

If the request is a PACK change request (step 98), the customer enters the number of the PACK to be changed and a description of the change (step 100) and the request is submitted (step 104). If Integrated Health Network (IHN) approval is required (step 104), the application 22 submits the request to IHN which determines whether the request is approved (step 106). If the request is approved, the application 22 generates an email to the service provider Sales Support Department with instructions to proceed with processing of the PACK change request (step 108). The Sales Support Department then processes the request (step 110). A new PACK quote with the requested changes is emailed by the Sales Support Department to the sales representative to present to the customer for signature. If the request is not approved, the application 22 generates an email to the customer to inform the customer that the requested PACK change cannot be implemented, and the service provider sales representative and IHN are copied (step 112). If IHN approval is not required (step 104), the service provider Sales Support Department proceeds with the processing of the request (step 110).

If the request involves a quality issue (step 114), the customer enters the number of the PACK, the lot number involved, and a description of the quality issue (step 116) and the request is submitted to the service provider's quality assurance department, preferably via email (step 118). The quality assurance department then processes the request (step 120) and sends a confirmation email to the customer with the results with a copy to IHN (step 122).

If the request does not involve a quality issue (step 114), the customer enters a description of the issue and the number of the PACK (if relevant)(step 124) and the request is submitted to the service provider's sales representative, preferably via email (step 126). The sales representative then processes the request (step 128) and sends a confirmation email to the customer with the results with a copy to IHN (step 122).

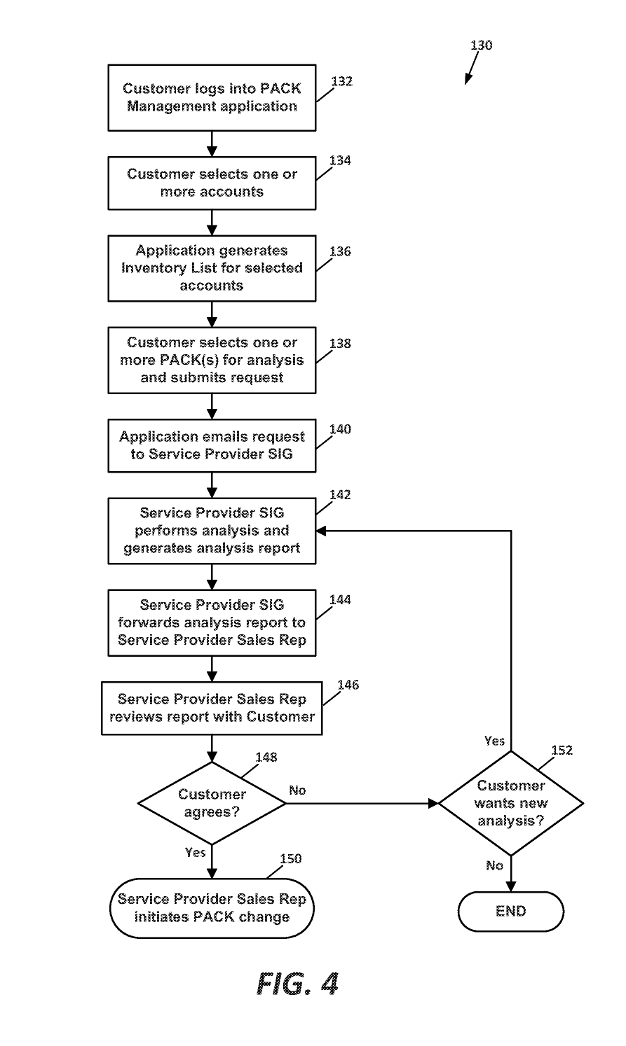

Using the optimization module 28 of the PACK management application 22, a customer may request that the service provider perform a PACK optimization analysis and send a resulting report to the customer. In a preferred embodiment, this module 28 provides a report that (1) identifies PACKs that can be standardized within a hospital or across a network of hospitals, (2) identifies the optimal number of PACKs within a hospital or across a network of hospitals, (3) determines the specific component configuration of the optimized custom procedure PACK, (4) calculates aggregate and procedural savings based on the optimized PACK combinations, and (5) compares current Bills of Materials to the service provider's low-cost line of standard PACKs. FIG. 4 depicts a process 130 for requesting and preparing an optimization report using the optimization module 28. Using a browser application running on the customer computer 18, a user logs into the PACK management application 22 running on service provider server 20 via the Internet 16 (step 132), and selects the customer account(s) for which an inventory list is to be generated (step 134). In one preferred embodiment, this selection is made using a dropdown list displayed in a browser window on the customer computer 18. Based on the selection, the optimization module 28 generates an inventory list for the selected account(s) (step 136). This list preferably includes all PACKs available to be ordered under the selected customer account. Using the graphical list, the user may check a box or other select one or more of the listed PACKs for analysis (step 138). The application 22 sends an email request to the service provider's system improvement group (SIG) to perform an analysis on the selected PACK(s) (step 140). The service provider SIG then performs the requested analysis and generates an electronic copy of an analysis report (step 142) and sends the report to the service provider sales representative via email (step 144). In performing the analysis, the SIG identifies the component bills of materials for the selected PACKs. These components are then categorized into functional groups and a crosstab analysis is performed, such as using Microsoft Access, to determine the similarity of functional groups with the selected PACKs. A listing of proposed PACK bills of materials is generated and provided to the sales representative to present to the customer. The service provider sales representative then goes over the report with the customer and explains the suggested optimization steps (step 146). If the customer agrees that the suggested steps should be implemented (step 148), the service provider sales representative takes appropriate action to initiate the PACK changes (step 150). In a preferred embodiment, this process is essentially the same as the initiation of the PACK change request described above. If the customer does not agree that the suggested steps should be implemented (step 148), and the customer wants a new analysis performed (step 152), the process loops back to step 142.

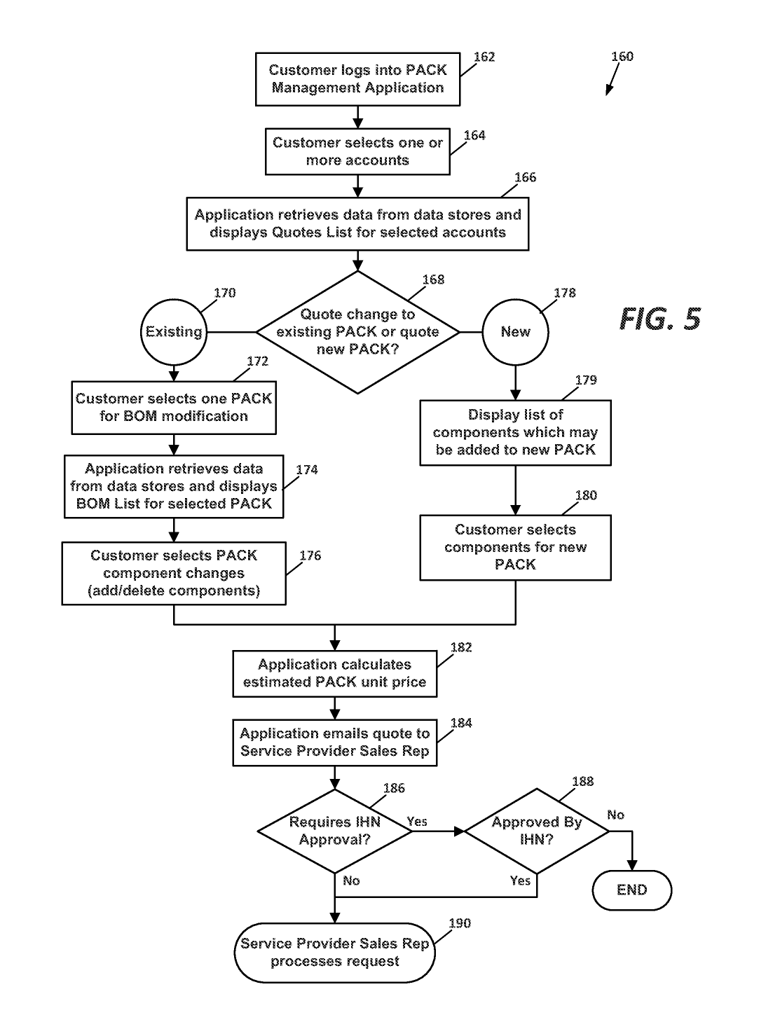

Using the quoting module 30 of the PACK management application 22, a customer may request that the service provider issue a quote for a PACK and the customer may view previously submitted quote requests. FIG. 5 depicts a process 160 for requesting a quote using the quoting module 30. Using a browser application running on the customer computer 18, a user logs into the PACK management application 22 running on service provider server 20 via the Internet 16 (step 162), and selects the customer account(s) for which a quote is to be requested (step 164). In one preferred embodiment, this selection is made using a dropdown list displayed in a browser window on the customer computer 18. Based on the selection, the quoting module 30 generates a quote list for the selected account(s) (step 166). This list preferably includes all PACKs for which quotes have been previously generated. If the customer desires a quote based on a production change to an existing PACK (step 168-170), the customer selects the PACK to be changed from the quotes list (step 172). The application 22 retrieves the data and displays the bill of material (BOM) for the selected PACK (step 174). The customer may then add components or delete components listed in the BOM (step 176) and the application 22 calculates a new estimated PACK unit price based on the changes (step 182). The application 22 emails the new quote to the service provider's sale representative (step 184). If IHN approval is needed, the application sends the new quote to IHN for consideration (step 186). If IHN approves (step 188), the service provider's sales representative communicates with the customer regarding the newly-quoted price for the PACK (step 190)

With continued reference to FIG. 5, if the customer desires a quote for a new PACK (steps 168 and 178), the application 22 displays a list of components from which the customer may choose to create a BOM for the new PACK (step 179). The customer then selects the components and the quantity of each to be added to create the new PACK (step 180), and the process continues at step 182 as described above to generate and approve a quote for the new PACK.

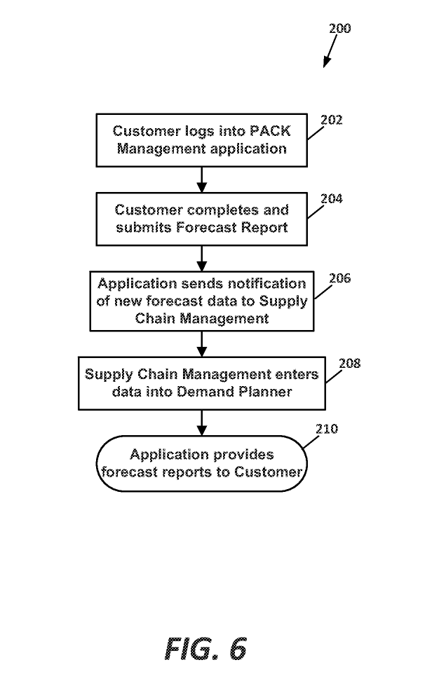

Using the forecast reporting module 32 of the PACK management application 22, a customer may complete and submit a forecast report to the service provider. As the term is used herein, a forecast report is a notification from the customer to the service provider of changes in quantity (either positive or negative) of upcoming requirements for PACKs. The resulting forecast data is used by the service provider's Supply Chain Management to plan manufacturing and purchasing requirements for PACK assemblies and their associated components. FIG. 6 depicts a process 200 for submitting a forecast report using the forecast reporting module 30. Using a browser application running on the customer computer 18, a user logs into the PACK management application 22 running on the service provider server 20 via the Internet 16 (step 202), and selects the forecast reporting option. The forecast reporting module 30 displays a form in which the customer may enter the forecast report to be submitted to the service provider (step 204). The application 22 sends a notification, such as via email, about the new forecast data to the supply chain manager of the service provider (step 206) and the supply chain manager enters the new forecast data into a demand planner program (step 208). The application 22 also sends a copy of the completed forecast report, such as via email, to the customer (step 210).

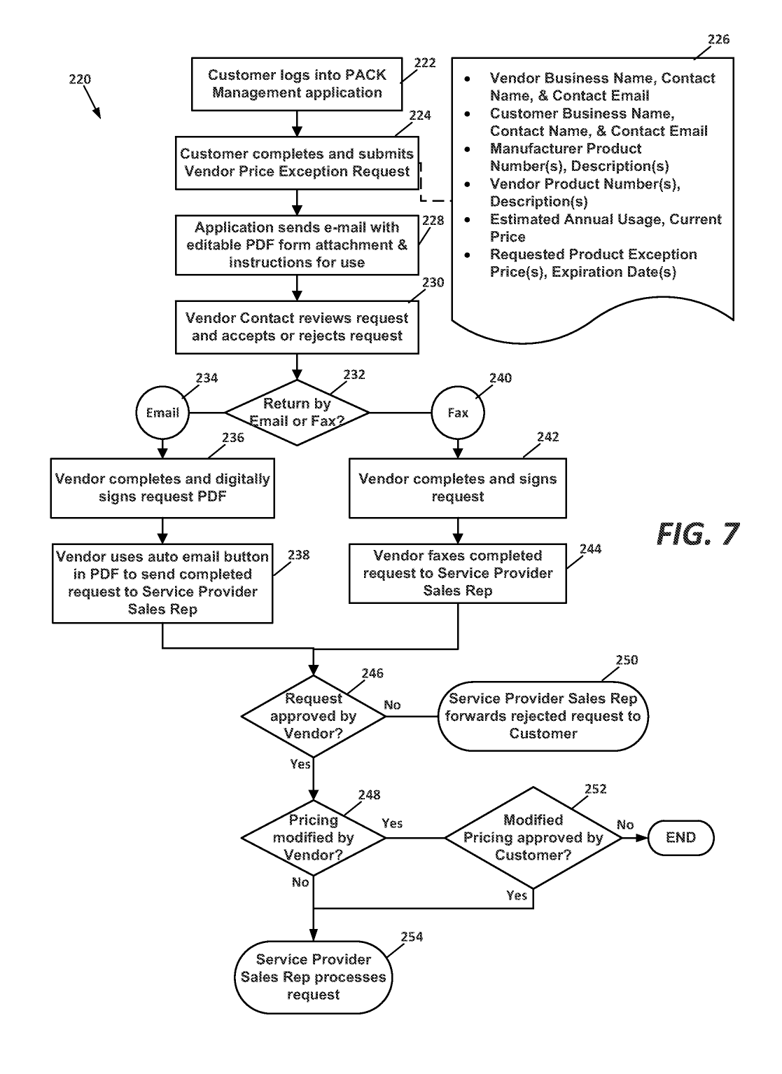

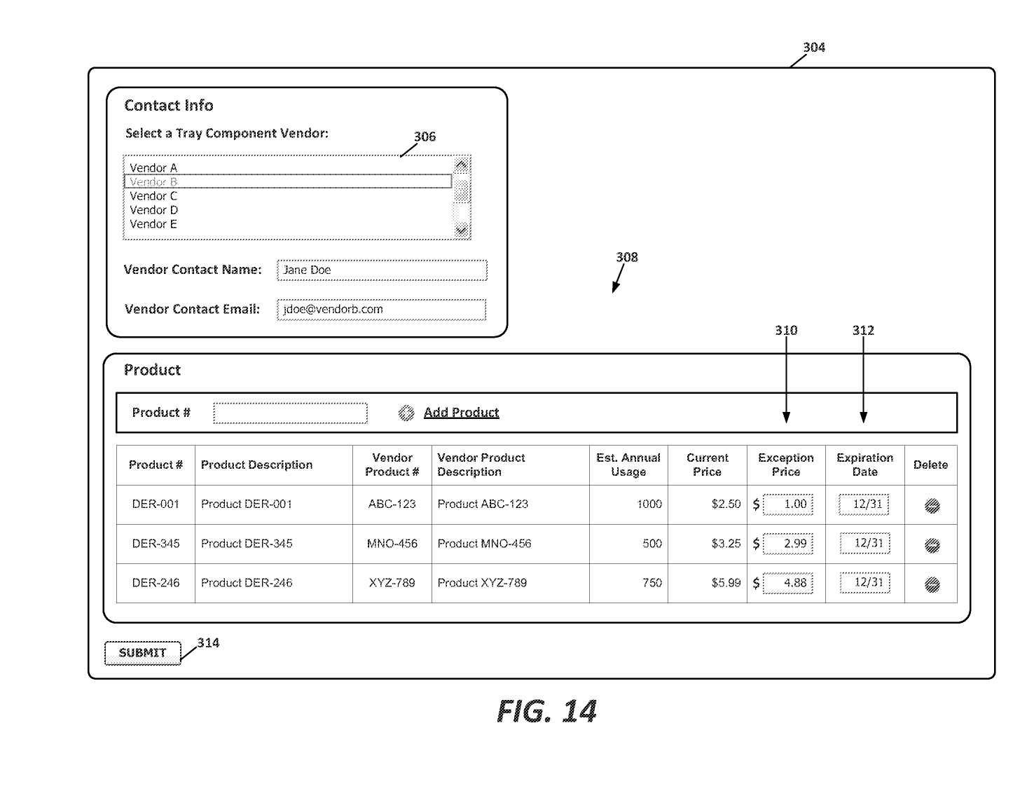

Using the vendor price exception request module 34 of the PACK management application 22, a customer may request that a vendor of a particular product in a PACK make an exception in the pricing of the product, such as by lowing the price. FIG. 7 depicts a process 220 for requesting and processing a price exception using the module 34. Using a browser application running on the customer computer 18, a user logs into the PACK management application 22 running on service provider server 20 via the Internet 16 (step 222), and selects the vendor price exception request option. The module 34 generates an input screen 304 as shown in FIG. 14 wherein the user may select the vendor to which the price exception request is to be directed. As shown in the embodiment of FIG. 14, this selection may be accomplished using a drop-down list 306. When the vendor is selected, a product list 308 is populated with products provided for PACK's by the selected vendor. For each product, this list 308 indicates the service provider's part number for the product, the service provider's product description, the vendor's part number for the product, the vendor's product description, the estimated annual usage of the product in PACK's, and the vendor's current price charged to the service provider for the product. The user may enter the desired exception price for each product in the column 310 and the expiration date for the exception pricing in column 312. After entering the price exception information, the user clicks the submit button 314 to submit the exception request to the vendor contact person (step 224). Preferably, each request includes the information shown in box 226 of FIG. 7.

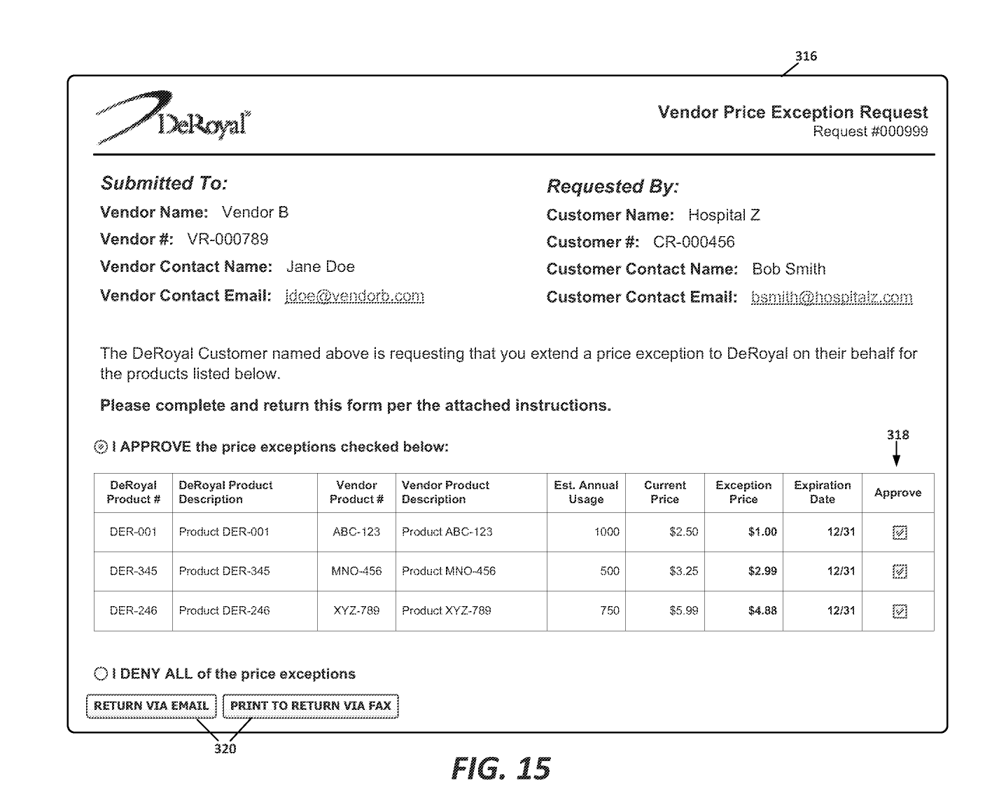

The application 22 then generates an email to the vendor contact with the price exception request attached along with instructions for processing the request (step 228). In one preferred embodiment, the request is sent as an editable PDF form 316, an example of which is depicted in FIG. 15. The vendor contact person then reviews the request and either approves or denies the request (step 230). For example, approval may be indicated by checking a box in the “Approve” column 318. The vendor contact person then signs the response (either digitally or physical) (step 236 or 242). The vendor's response may be sent to the service provider sales representative by email or fax (step 232) by selecting the appropriate button 320 on the form 316. If by email, the vendor may click on an email button in the form 316 to automatically generate an email to the sales representative (step 238), and if by fax, the vendor faxes the form 316 to the sales representative (step 244).

If the service provider sales representative sees that the pricing exception was approved by the vendor (step 246) with no modification of the requested price (step 248), the sales representative processes the approved request by changing the product pricing in the service provider's records (step 254). If the vendor did not approve the request (step 246), the sales representative forwards the rejected request to the customer (step 250). If the vendor approved the request (step 246) but with modifications to the price or expiration date (step 248), the sales representative forwards the modified pricing to the customer for consideration. If the customer agrees to the modifications (step 252), the sales representative processes the approved request by changing the product pricing in the service provider's records (step 254).

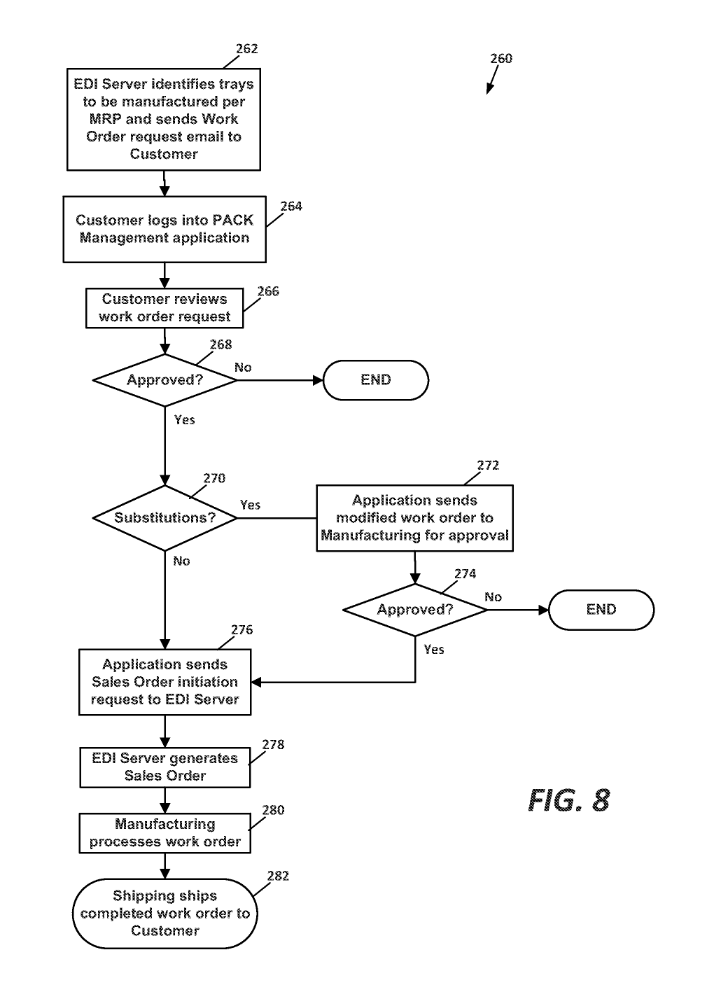

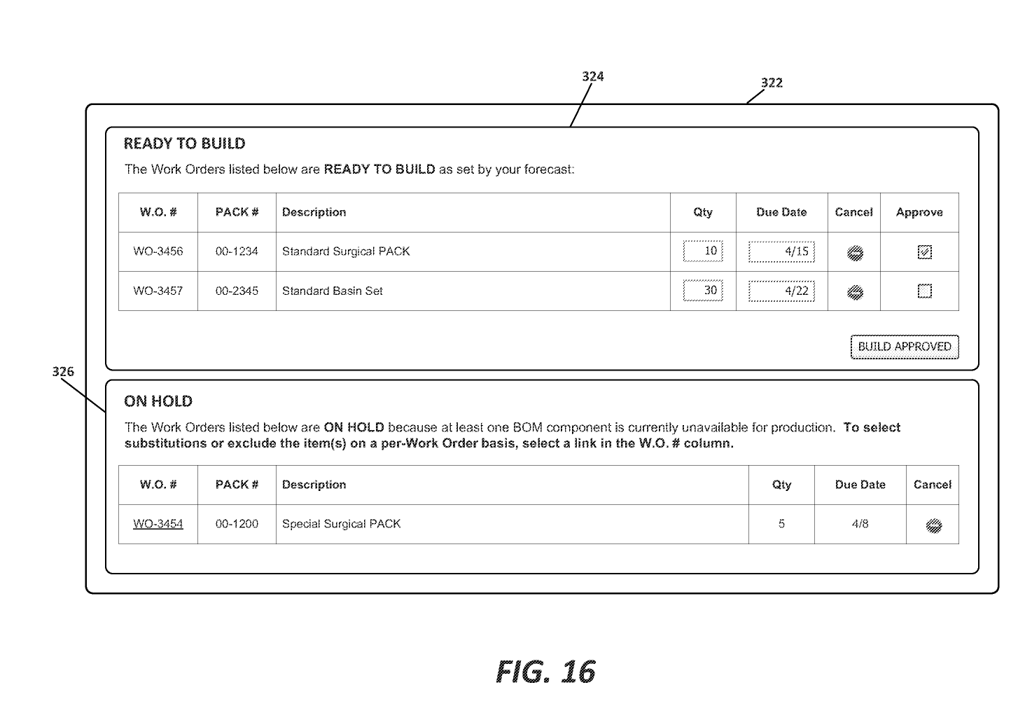

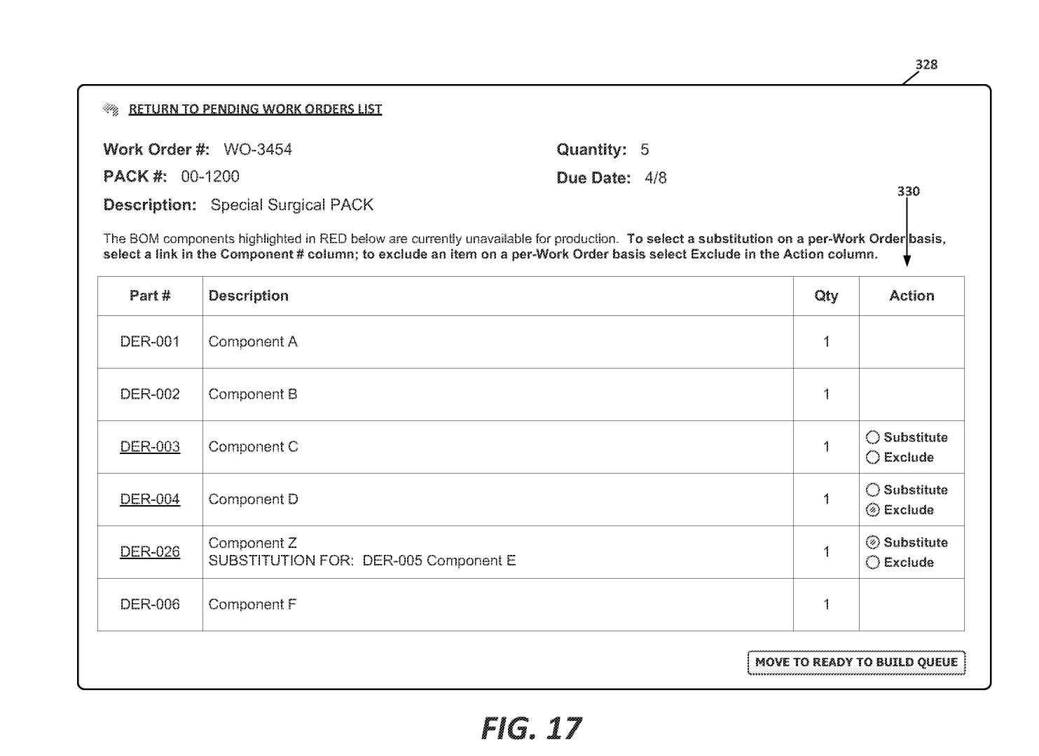

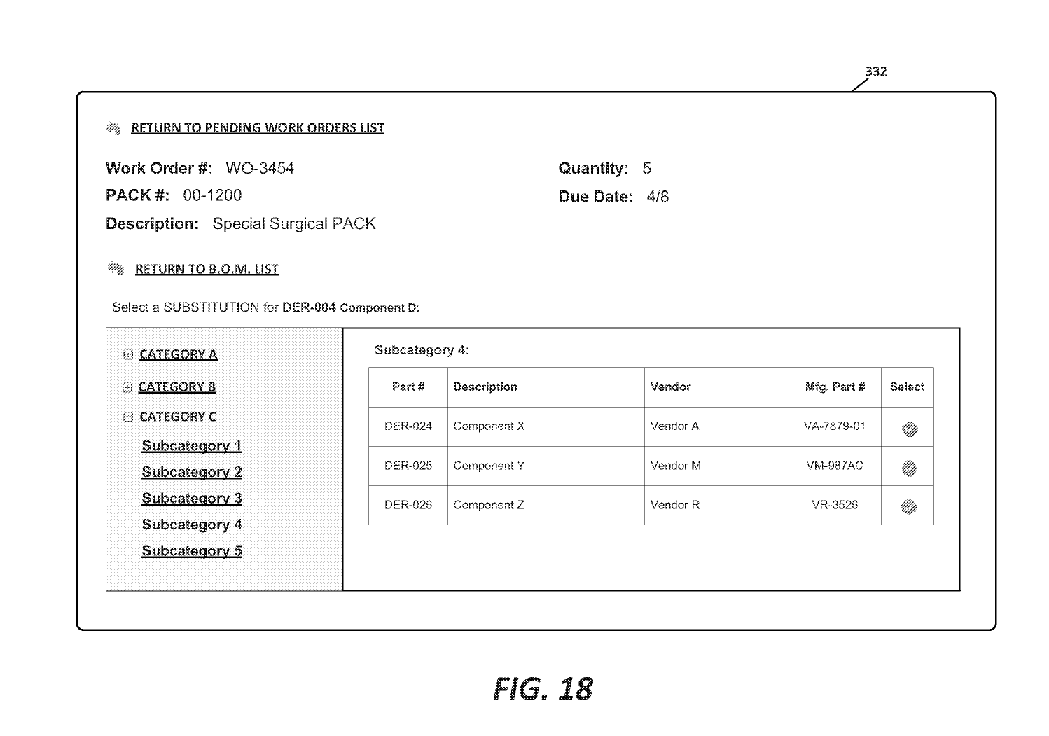

Using the work order management module 36 of the PACK management application 22, the service provider's material requirements planning (MRP) department may request that a customer consider a change to a pending work order when one or more components of a PACK are unavailable for production. FIG. 8 depicts a process 260 for requesting and processing a work order change using the module 36. In a preferred embodiment, this process begins when the EDI server 42 identifies one or more PACK's to be manufactured which require components that are currently unavailable, and the EDI server 42 or the application 22 sends an email to the customer contact person notifying the customer that a work order change request is pending (step 262). Using a browser application running on the customer computer 18, a user logs into the PACK management application 22 running on service provider server 20 via the Internet 16 (step 264), and selects the work order management option. The module 36 generates a pending work orders list 322 as shown in FIG. 16 which indicates pending work orders that are ready to build 324 and those on hold 326 because of unavailable components. If the user clicks on the work order number of a work order in the “on hold” list, a BOM list 328 for the selected work order is displayed as shown in FIG. 17. The “Action” column 330 in the list 328 indicates BOM components that are currently unavailable for production, along with a request to either exclude the component from the BOM or substitute another component. The user reviews this request (step 266) and, for each lacking component, either approves an exclusion (step 268) or chooses to make a substitution (step 270) in the column 330. If the user selects a substitution, the application 22 generates a substitution selection screen 332 as shown in FIG. 18. From this screen, the user may select a substitute component, such as from another vendor, to be included in the BOM in place of the unavailable component.

Once the substitution selection is made, the application 22 sends a modified work order to manufacturing 38 for approval (step 272). If manufacturing approves the substitution (step 274), the application 22 sends a sales order initiation request to the EDI server 42 (step 276) which generates a sales order (step 278). Manufacturing 38 then processes the work order (step 280) and the shipping department ships the completed order to the customer (step 282).

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

What is claimed is:

1. A system for incorporating requests from a customer in determining configuration and pricing of custom medical procedural kits ordered by the customer from a service provider, wherein the configuration and pricing of the custom medical procedural kits is managed by the service provider, the system comprising:
a service provider computer in communication with a customer computer via a communication network, the service provider computer for executing a custom procedural kit management application to receive customer requests via the communication network and process the customer requests in determining the configuration and pricing of custom medical procedural kits,
the custom procedural kit management application configured to enable a customer to access a list of components of one or more custom procedural kits associated with a customer account maintained by the service provider for the customer, wherein the list of components is accessible through the communication network for display on the customer computer with no necessity for personnel of the customer to interact with personnel of the service provider, and
a custom procedural kit database in communication with the custom procedural kit management computer, the custom procedural kit database for storing configuration information and pricing information for each custom procedural kit associated with the customer account.

2. The system of claim 1 wherein the custom procedural kit management application is configured to receive a customer request to change the configuration of one or more of the custom procedural kits associated with the customer account, wherein the customer request is submitted from the customer computer via the communication network to the service provider computer with no necessity for personnel of the customer to interact with personnel of the service provider.

3. The system of claim 1 wherein the custom procedural kit management application is configured to receive a customer request for the service provider to perform an optimization analysis of one or more of the custom procedural kits associated with the customer account, wherein the customer request is submitted from the customer computer via the communication network to the service provider computer with no necessity for personnel of the customer to interact with personnel of the service provider.

4. The system of claim 1 wherein the custom procedural kit management application is configured to:
receive a customer request to add a component to or delete a component from one or more of the custom procedural kits associated with the customer account;
calculate a new price for the one or more custom procedural kits in which a component is added or deleted; and
generate a price quote for the one or more custom procedural kits in which a component is added or deleted based on the new price,
wherein the customer request is submitted, the new price is calculated, and the price quote is generated with no necessity for personnel of the customer to interact with personnel of the service provider.

5. The system of claim 1 wherein the custom procedural kit management application is configured to receive a forecast report from the customer for one or more of the custom procedural kits associated with the customer account, wherein the forecast report is submitted from the customer computer via the communication network to the service provider computer with no necessity for personnel of the customer to interact with personnel of the service provider.

6. The system of claim 1 wherein the custom procedural kit management application is configured to receive an electronic vendor price exception request form submitted by the customer, wherein the electronic vendor price exception request form is directed to a vendor that supplies one or more components of one or more of the custom procedural kits associated with the customer account.

7. The system of claim 6 wherein the custom procedural kit management application generates the electronic vendor price exception request form for the customer to complete and sends the electronic vendor price exception request form from the service provider computer via the communication network to the vendor with no necessity for personnel of the customer to interact with personnel of the service provider.

8. The system of claim 7 wherein the custom procedural kit management application sends to the vendor an electronic message containing the electronic vendor price exception request form submitted by the customer, wherein the electronic message is sent from the service provider computer via the communication network.

9. The system of claim 6 wherein the electronic vendor price exception request form includes means in the form for the vendor to electronically enter approval or disapproval of the vendor price exception request.

10. The system of claim 6 wherein the electronic vendor price exception request form includes means in the form for the vendor to electronically choose to email the electronic vendor price exception request form to the service provider after the vendor has entered approval or disapproval in the form.

11. The system of claim 1 wherein the custom procedural kit management application is operable to generate a work order list indicating pending work orders for the custom procedural kits associated with the customer account, wherein the work order list indicates pending work orders that are ready to build and pending work orders that are on hold because one or more components of a custom procedural kit are unavailable, wherein the custom procedural kit management application is operable to allow the customer to access the work order list via the communication network and view the work order list on the customer computer with no necessity for personnel of the customer to interact with personnel of the service provider.

12. The system of claim 11 wherein the custom procedural kit management application is operable to generate a component list indicating components of a custom procedural kit associated with a work order that is on hold because one or more components of the custom procedural kit are unavailable, wherein the component list includes means for the customer to electronically enter a choice to exclude an unavailable component from the custom procedural kit or a choice to substitute another component for the unavailable component, wherein the customer choice may be entered without personnel of the customer interacting with personnel of the service provider.

13. The system of claim 12 wherein the custom procedural kit management application is operable to receive the customer choice, generate a modified work order based on the customer choice, and electronically send the modified work order to manufacturing for approval.

14. The system of claim 12 wherein the custom procedural kit management application is operable to generate a request for a sales order for the modified work order, and electronically send the request for the sales order to an electronic data interchange server in communication with the custom procedural kit management computer.

15. A method for incorporating requests from a customer in determination of configuration and pricing of custom medical procedural kits ordered by the customer from a service provider, wherein the configuration and pricing of the custom medical procedural kits are managed by the service provider, the method implemented using a service provider computer in communication with a customer computer via a communication network, the service provider computer also in communication with a custom procedural kit database, the method comprising:
(a) storing in the custom procedural kit database configuration information and pricing information for one or more custom procedural kits associated with a customer account maintained by the service provider for the customer;
(b) accessing from the custom procedural kit database a list of components of the one or more custom procedural kits associated with the customer account;
(c) communicating the list of components through the communication network from the service provider computer to the customer computer;
(d) displaying the list of components on the customer computer;
(e) communicating a customer request through the communication network from the customer computer to the service provider computer, the customer request related to one or more of the configuration and pricing of the one or more custom medical procedural kits associated with the customer account; and
(f) determining one or more of the configuration and pricing of one or more of the custom medical procedural kits associated with the customer account based at least in part on the customer request,
wherein at least steps (b), (c), (d), (e) and (f) are accomplished with no necessity for personnel of the customer to interact with personnel of the service provider.

16. The method of claim 15 wherein step (e) comprises communicating a customer request to change the configuration of one or more of the custom procedural kits associated with the customer account.

17. The method of claim 15 wherein step (e) comprises communicating a customer request for the service provider to perform an optimization analysis of one or more of the custom procedural kits associated with the customer account.

18. The method of claim 15 wherein
step (e) includes communicating a customer request to add a component to or delete a component from one or more of the custom procedural kits associated with the customer account, and
step (f) includes calculating a new price for the one or more custom procedural kits in which a component is added or deleted, and
further comprising
(g) generating a price quote for the one or more custom procedural kits in which a component is added or deleted based on the new price.

19. The method of claim 15 wherein step (e) includes communicating an electronic vendor price exception request form from the customer computer to a vendor that supplies one or more components of one or more of the custom procedural kits associated with the customer account.

20. The method of claim 15 further comprising the vendor entering approval or disapproval of the vendor price exception request in the electronic vendor price exception request form.
